(19) United States
(12) Patent Application Publication
(10) Pub. No.: US 2025/0141281 A1
(43) Pub. Date: May 1, 2025

(54) STATOR FOR AN E-MOTOR WITHOUT VARNISH TRICKLING

(71) Applicant: Ford Global Technologies, LLC, Dearborn, MI (US)

(72) Inventors: Xiaogang Zhang, Novi, MI (US); Christopher Robert Galante, Canton, MI (US); Ian George Eickholdt, Warren, MI (US)

(73) Assignee: Ford Global Technologies, LLC, Dearborn, MI (US)

(21) Appl. No.: 18/494,131

(22) Filed: Oct. 25, 2023

(51) Int. Cl. H02K 1/16; H02K 3/02; H02K 3/487

(52) U.S. Cl. CPC H02K 1/16; H02K 3/02; H02K 3/487

(57) ABSTRACT

A stator for an e-motor includes a body with a first end and a second end, a first plate mounted to the first end of the body, a second plate mounted to the second end of the body, and a plurality of wires and insulation extending through the first plate, the body of the stator and the second plate. The first plate and the second plate inhibit relative movement between individual wires of the plurality of wires and the body of the stator.

### FIELD

The present disclosure relates to stators for electric motors. More specifically, the present disclosure relates to the elimination of varnish trickling during the production of stators.

### BACKGROUND

The statements in this section merely provide background information related to the present disclosure and may not constitute prior art.

Electric propulsion in vehicles provide an alternative to internal combustion engines. The electric propulsions use electric motors to propel the vehicle. Applying varnish to such motors provides corrosion and contaminant resistance to the motors, increasing an operation lifetime of the electric propulsion. The varnish can be applied with a machine designed to apply the varnish to the various components of the motors. In some situations, however, the varnish does not fill a gap between the electric motor's stator and insulation paper and between the insulation paper and conductive wires that extend through the stator.

The present disclosure addresses challenges related to varnish application to electric motors.

### SUMMARY

This section provides a general summary of the disclosure and is not a comprehensive disclosure of its full scope or all of its features.

In one form of the present disclosure, a stator for an e-motor includes a body with a first end and a second end, a first plate mounted to the first end of the body, a second plate mounted to the second end of the body, and a plurality of wires and insulation extending through the first plate, the body of the stator and the second plate. The first plate and the second plate inhibit relative movement between individual wires of the plurality of wires and the body of the stator.

In variations of this stator, which may be implemented individually or in any combination: the first plate and the second plate are made of a plastic; the plastic material is a polyamidepimide, a polyphenylene sulfide, or a polyphenylene oxide; the first plate and the second plate are made of a ceramic material; the first plate and the second plate are molded as a single integrated piece; the first plate and the second plate are formed from two separate molded pieces; the plurality of wires comprise a copper material; and the bending of the plurality of wires applies a force to the first plate and the second plate to inhibit relative movement between the stator and individual wires of the plurality of wires.

In another form, a stator for an e-motor includes a body with a plurality of slots, a plurality of wires and insulation extending through the body, and at least one insert that extends from an outer diameter to an inner diameter of a slot of the body and through at least a portion of the plurality of wires. The at least one insert inhibits relative movement between individual wires of the plurality of wires.

In variations of this form, which may be implemented individually or in any combination: the at least one insert comprises a T-shaped portion and a wedge-shaped portion; the T-shaped portion comprises an elongated segment; the elongated segment is tapered; the at least one insert is made of a plastic material; the plastic material is a polyamidepimide, a polyphenylene sulfide, or a polyphenylene oxide; the at least one insert is made of a ceramic material; and the at least one insert comprises a plurality of inserts that are spaced apart.

In yet another form, a stator for an e-motor includes a body with a plurality of slots, a plurality of wires and insulation extending through the body, at least one insert that extends from an outer diameter to an inner diameter of a slot of the body and through at least a portion of the plurality of wires, at least another insert that extends from the inner diameter to a mid-point between the outer diameter and the inner diameter of the slot of the body and through the sub portion of the plurality of wires. The at least one insert and the at least another insert inhibit relative movement between individual wires of the plurality of wires.

In variations of this method, which may be implemented individually or in any combination: each of the at least one insert and the at least another insert includes a T-shaped elongated portion and a wedge-shaped portion; the T-shaped elongated portion comprises a tapered segment; and the stator further comprises a mechanism that locks the at least one insert and the another insert together at the mid-point to inhibit movement between individual wires of the plurality of wires.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a stator of an electric motor in accordance with the principals of the present disclosure;

FIG. 2 illustrates the stator with two annulus discs in accordance with the principals of the present disclosure;

FIG. 3A illustrates a portion of an annulus disc formed from two separate layers in accordance with the principals of the present disclosure;

FIG. 3B illustrates the portion of the annulus disc shown in FIG. 3A when the two layers are combined in accordance with the principals of the present disclosure;

FIG. 4A is a cross-sectional view of the annulus disc as seen along the lines 4A-4A of FIG. 3B in accordance with the principals of the present disclosure;

FIG. 4B is a cross-sectional view of the annulus disc along the plane 4B-4B of FIG. 4A in accordance with the principals of the present disclosure;

FIG. 4C is a cross-section view of the annulus disc along the plane 4C-4C of FIG. 4A in accordance with the principals of the present disclosure;

FIG. 5A illustrates a portion of another annulus disc formed from two separate layers in accordance with the principals of the present disclosure;

FIG. 5B illustrates the portion of the annulus disc shown in FIG. 5A when the two layers are combined in accordance with the principals of the present disclosure;

FIG. 6A is a cross-sectional view of the annulus disc as seen along the lines 6A-6A of FIG. 5B in accordance with the principals of the present disclosure;

FIG. 6B is a cross-sectional view of the annulus disc along the plane 6B-6B of FIG. 6A in accordance with the principals of the present disclosure;

FIG. 6C is a cross-section view of the annulus disc along the plane 6C-6C of FIG. 6A in accordance with the principals of the present disclosure;

FIG. 7 illustrates an annulus disc inhibiting relative movement of individual wires in a stator in accordance with the principals of the present disclosure;

FIG. 8A is a perspective view of a wedge that inhibits relative movement of individual wires in a stator in accordance with the principals of the present disclosure;

FIG. 8B is a cross-sectional view of the wedge as seen along the lines 8B-8B of FIG. 8A in accordance with the principals of the present disclosure;

FIG. 8C is a cross-sectional view of the wedge as seen along the lines 8C-8C of FIG. 8A in accordance with the principals of the present disclosure;

FIG. 8D is a cross-sectional view of the wedge as seen along the lines 8D-8D of FIG. 8A in accordance with the principals of the present disclosure;

FIG. 9A illustrates the wedge positioned in place in a plurality of wires of a stator in accordance with the principals of the present disclosure; and

FIG. 9B illustrates two wedges positioned in place in a plurality of wires of a stator in accordance with the principals of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

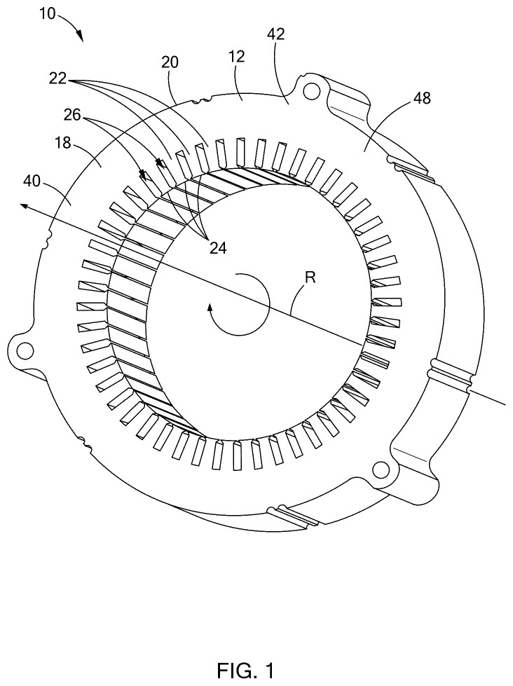

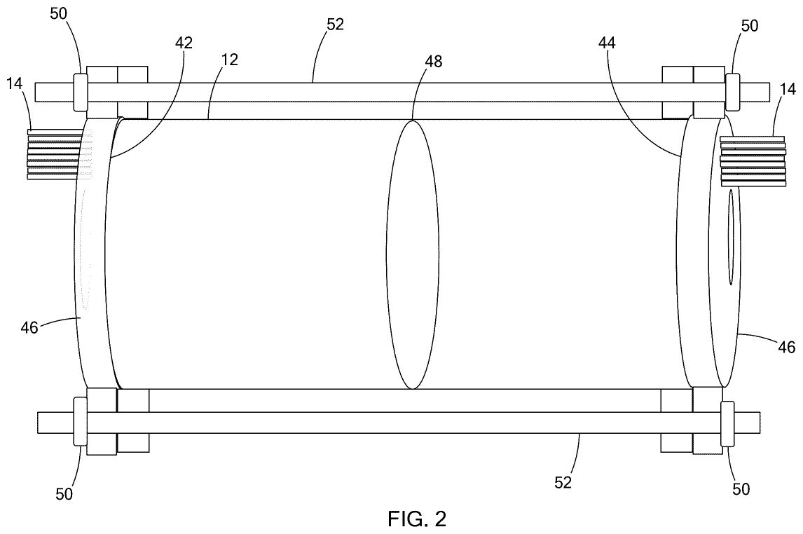

With reference to FIGS. 1 and 2, an electric motor 10 includes a stator 12 and a plurality of wires 14. The electric motor 10 is a component of an electric propulsion for a motor vehicle, i.e., an “electric vehicle.” The electric motor 10 propels the motor vehicle by rotating one or more wheels of the motor vehicle. In one example, the electric motor 10 is a sole propulsion of the vehicle, e.g., in a fully electric vehicle. Alternatively, the electric motor 10 can be part of a hybrid propulsion that includes an internal combustion engine, e.g., in a hybrid-electric vehicle.

The electric motor 10 includes the stator 12. The stator 12 is a stationary component of the electric motor 10 that provides a magnetic field by which a rotor rotates. The stator 12 maintains alignment of the magnetic field to rotate the rotor. The stator 12 includes a plurality of laminates 18, i.e., sheets of material fused together. Each laminate 18 is an annular sheet of metal with a continuous outer edge 20 defining an outer diameter and a plurality of fingers 22 extending toward a center point of the annular sheet. Distal ends 24 of the fingers 22 define an inner diameter of the laminate 18. Each pair of adjacent fingers 22 of one of the laminates 18 defines a slot 26 therebetween. The slots 26 extend radially from the inner diameter to an intermediate diameter. The laminates 18 are fused at the outer diameter by, e.g., a weld, and the laminates 18 are free at the intermediate diameter and the inner diameter. The stator 12 includes a first laminate 40 at a first end 42 of the stator 12 to a last laminate at a second end 44. The laminates 18 have outer surfaces 48 that are in contact with outer surfaces of adjacent laminates 18.

The wires 14 are an electrically conducting material, e.g., copper. The wires 14 provide electricity to generate the magnetic field that drives the rotor. The wires 14 are disposed in the slots 26 and extend along the stator 12. The wires 14 are disposed from the intermediate diameter to the inner diameter in the slots 26 defined by the fingers 22 of the laminates 18.

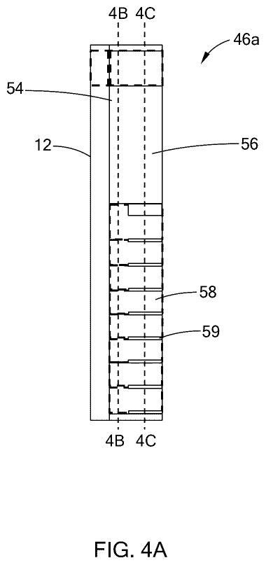

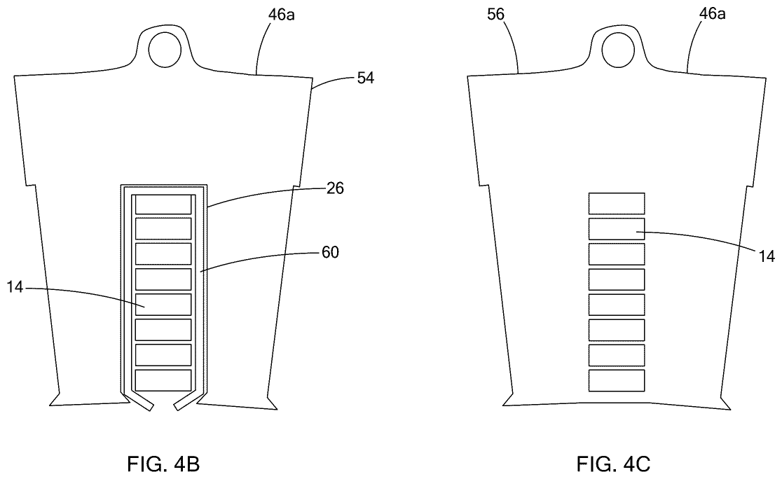

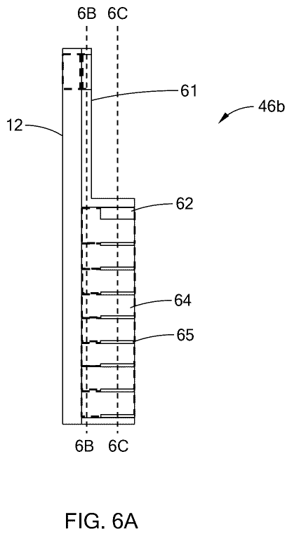

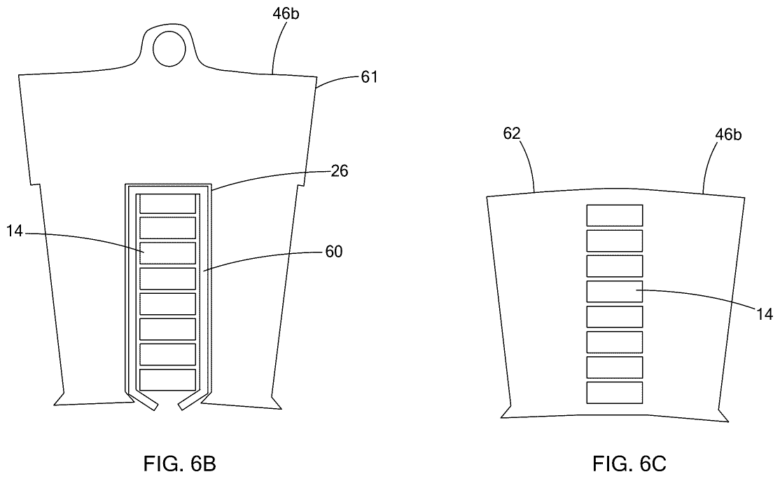

A plate, such as an annulus disc 46 is disposed at a first end 42 and a second end 44. The annulus discs 46 are bolted to the stator 12 with a set of nuts 50 and a set of rods 52. The annulus discs 46 are mirrored along a center plane 48 of the stator 12. As shown in FIGS. 4B and 6B, an insulating layer 60 is positioned in each slot 26 between the wires 14 and the stator 12. The insulating layer 60 reduces or inhibits electric conduction between the wires 14 and the stator 12. The insulating layer 60 is, e.g., a paper layer that is electrically insulative. Each of the annulus discs are formed from a ceramic or plastic material. For example, but not limited to, the plastic material can be polyamidepimide, polyphenylene sulfide, or polyphenylene sulfide.

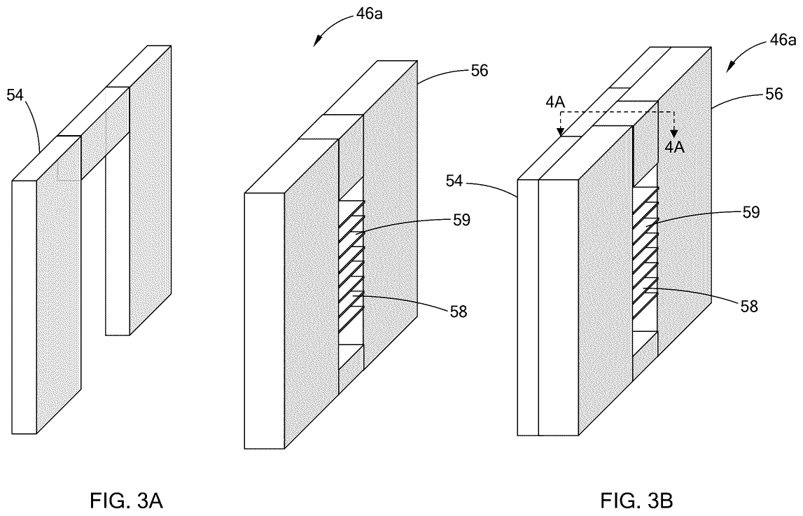

In one form, a portion of an annulus disc 46 is shown as 46a in FIGS. 3A and 3B. The portion of the annulus disc 46a surrounds a single slot 26 of the stator 12 and is formed from two layers 54 and 56. The layer 54 is disposed adjacent to the stator 12, and the layer 56 includes a set of slots 58 defined by a set of plates 59 that direct a portion of the plurality of wires through the layer 54 into the stator 12. The layer 54 in some forms can be formed from paper. The slots 58 separate the plurality of wires 14 and inhibit relative movement between the wires 14. Rather than formed from two separate layers, the annulus disc 46a can be molded as a single integrated piece.

Referring further to FIG. 4A, there is shown a cross-sectional view of the annulus disc 46a, as viewed along the lines 4A-4A of FIG. 3B, attached to the stator 12. FIG. 4B shows a cross-sectional view along the plane 4B-4B of the inner layer 54, and FIG. 4C shows a cross-sectional view along the plane 4C-4C of the outer layer 56. The inner layer 54 of the annulus disc 46a provides room for the insulating layers 60 and the plurality of wires 14, while the outer layer 56 provides room only for the plurality of wires 14. Each wire of the plurality of wires 14 is sandwich between the plates 59 that define the slots 58 and are separated from other copper wires to inhibit movement between the wires 14. As shown in FIGS. 2 and 4B, the plurality of wires 14 and insulation 60 extend through the annulus disc 46 at the first end 42 of the stator 12, the body of the stator 12, and the annulus disc 46 at the second send 44 of the stator 12.

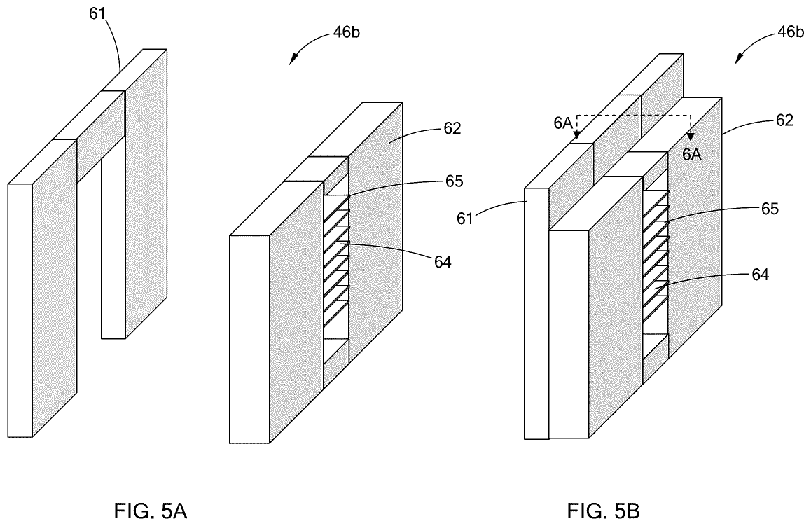

In another form, a portion of the annulus disc 46 is shown as 46b in FIGS. 5A and 5B. Again, the portion of the annulus disc 46b surrounds a single slot 26 of the stator 12 and is formed from two layers 61 and 62. The layer 61 is disposed adjacent to the stator 12, and the layer 62 includes a set of slots 64 defined by a set of plates 65 that direct a portion of the plurality of wires into the stator 12. The layer 61 in some forms can be formed from paper. The slots 64 separate the plurality of wires 14 and inhibit relative movement between the wires 14. Rather than formed from two separate layers, the annulus disc 46b can be molded as a single integrated piece.

Referring further to FIG. 6A, there is shown a cross-sectional view of the annulus disc 46b, as viewed along the lines 6A-6A of FIG. 5B, attached to the stator 12. FIG. 6B shows a cross-sectional view along the plane 6B-6B of the inner layer 61, and FIG. 6C shows a cross-sectional view along the plane 6C-6C of the outer layer 62. The inner layer 61 of the annulus disc 46b provides room for the insulating layers 60 and the plurality of wires 14, while the outer layer 62 provides room only for the plurality of wires 14. Each wire of the plurality of wires 14 is sandwich between the plates 65 that define the slots 64 and are separated from the other copper wires to inhibit movement between the wires 14. As shown in FIGS. 2 and 6B, the plurality of wires 14 and insulation 60 extend through the annulus disc 46 at the first end 42 of the stator 12, the body of the stator 12, and the annulus disc 46 at the second send 44 of the stator 12.

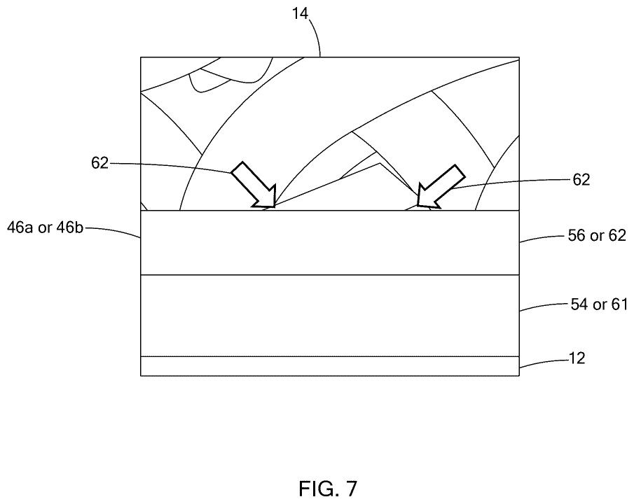

Accordingly, the present disclosure describes the use of annulus discs 46a or 46b structurally integrated to the stator 12 and the plurality of wires 14 as a rigid single part, as shown in FIG. 7. No relative movement is allowed between individual wires of the plurality of wires 14 and between the stator 12 and the plurality of wires 14. Near the outer diameter of the stator 12 and the annulus discs 46a or 46b, the annulus discs 46a or 46b are attached to the stator 12 with a set of nuts 50 and a set of rods 52 (FIG. 2). Near the inner diameter of the stator 12 and the annulus discs 46a or 46b, bending of the plurality of wires 14 creates a force 62 that pushes against the outer layers 56 or 62 to hold the plurality of wires 14 against the stator 12. The plates 59 or 65 inside the outer layers 56 or 62 of the annulus discs 46a or 46b hold each individual wire of the plurality of wires 14 to inhibit movement of the individual wires with respect to the stator 12.

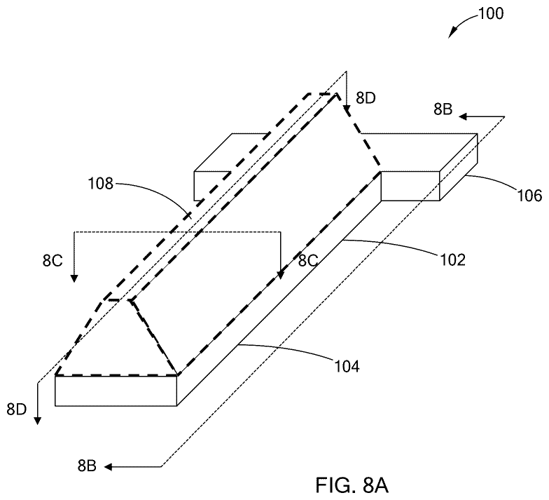

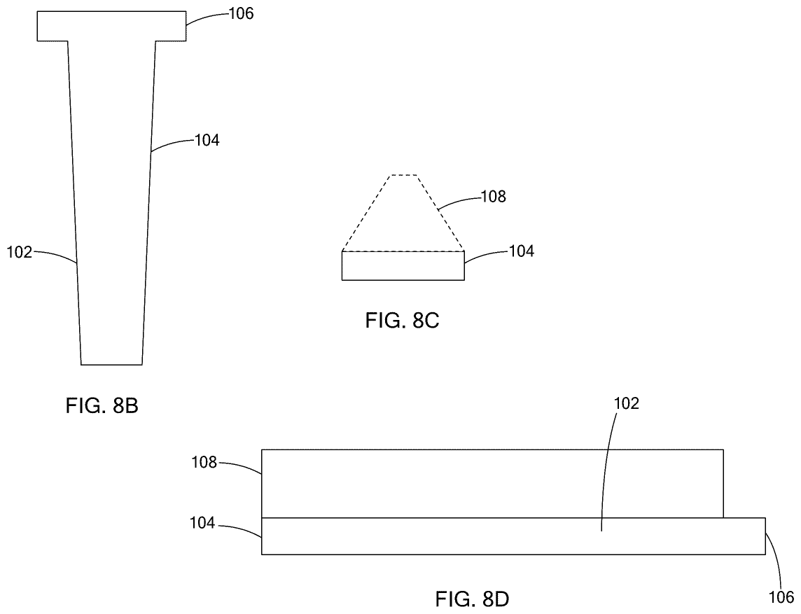

Turning now to FIGS. 8A through 8D, there is shown an insert 100 that inhibits relative movement between the wires of the plurality of wires 14. The insert 100 includes a flat T-shaped portion 102 made of an elongated segment 104 and a top segment 106. A wedge-shaped portion 108 is attached to the elongated segment 104. As illustrated in FIG. 8B, the elongated segment 104 is tapered. As such, the taper of the elongated segment 104 and the shape of the wedge-shaped portion 108 enables placement of the insert 100 through the plurality of wires 14.

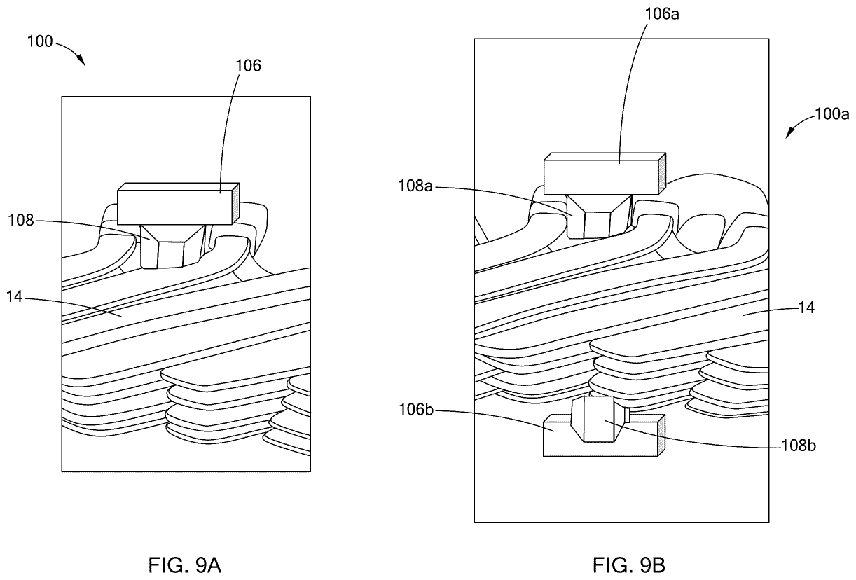

In one arrangement, as shown in FIG. 9A, the insert 100 is placed through a portion of the plurality of wires 14. That is, the insert 100 extends from an outer diameter to an inner diameter of a respective slot 26 of the body of the stator 12 and through a sub portion of the plurality of wires 14 to inhibit relative movement between individual wires of the plurality of wires 14. In various arrangements, multiple inserts 100 may be utilized.

In another arrangement, as shown in FIG. 9B, a pair of inserts 106a and 106b is utilized. One insert 106a extends from an outer diameter to a mid-point between the outer diameter and the inner diameter of the slot 26 of the body of the stator 12 and through the sub portion of the plurality of wires 14, and another insert 106b extends from the inner diameter to the mid-point between the outer diameter and the inner diameter of the slot 26 of the body of the stator 12 and through the sub portion of the plurality of wires 14. A mechanism locks the two inserts 106a and 106b together at the mid-point to inhibit movement between individual wires of the plurality of wires 14. In various arrangements, multiple insert pairs 106a and 106b 100 may be utilized.

In various arrangements, the inserts shown in FIGS. 8A-8D, 9A and 9B are made of a ceramic or plastic material. The plastic material can be polyamidepimide, polyphenylene sulfide, or polyphenylene sulfide.

Among other advantages and benefits, the present disclosure describes assemblies that eliminate varnish trickling from the production of e-motors. Hence, these assemblies reduce the process complexities associated with the production of e-motors.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A stator for an e-motor, the stator comprising:
a body with a first end and a second end;
a first plate mounted to the first end of the body;
a second plate mounted to the second end of the body; and
a plurality of wires and insulation extending through the first plate, the body of the stator and the second plate,
wherein the first plate and the second plate inhibit relative movement between individual wires of the plurality of wires and the body of the stator.

2. The stator of claim 1, wherein the first plate and the second plate are made of a plastic material.

3. The stator of claim 2, wherein the plastic material is a polyamidepimide, a polyphenylene sulfide, or a polyphenylene oxide.

4. The stator of claim 1, wherein the first plate and the second plate are made of a ceramic material.

5. The stator of claim 1, wherein the first plate and the second plate are molded as a single integrated piece.

6. The stator of claim 1, wherein the first plate and the second plate are formed from two separate molded pieces.

7. The stator of claim 1, wherein the plurality of wires comprises a copper material.

8. The stator of claim 1, wherein the bending of the plurality of wires applies a force to the first plate and the second plate to inhibit relative movement between the stator and individual wires of the plurality of wires.

9. A stator for an e-motor, the stator comprising:
a body with a plurality of slots;
a plurality of wires and insulation extending through the body; and
at least one insert that extends from an outer diameter to an inner diameter of a slot of the body and through at least a portion of the plurality of wires,
wherein the at least one insert inhibits relative movement between individual wires of the plurality of wires.

10. The stator of claim 9, wherein the at least one insert comprises a T-shaped portion and a wedge-shaped portion.

11. The stator of claim 10, wherein the T-shaped portion comprises an elongated segment.

12. The stator of claim 11, wherein the elongated segment is tapered.

13. The stator of claim 9, wherein the at least one insert is made of a plastic material.

14. The stator of claim 13, wherein the plastic material is a polyamidepimide, a polyphenylene sulfide, or a polyphenylene oxide.

15. The stator of claim 9, wherein the at least one insert is made of a ceramic material.

16. The stator of claim 9, wherein the at least one insert comprises a plurality of inserts that are spaced apart.

17. A stator for an e-motor, the stator comprising:
a body with a plurality of slots;
a plurality of wires and insulation extending through the body;
at least one insert that extends from an outer diameter to an inner diameter of a slot of the body and through at least a portion of the plurality of wires;
at least another insert that extends from the inner diameter to a mid-point between the outer diameter and the inner diameter of the slot of the body and through the sub portion of the plurality of wires,
wherein the at least one insert and the at least another insert inhibit relative movement between individual wires of the plurality of wires.

18. The stator of claim 17, wherein each of the at least one insert and the at least another insert includes a T-shaped elongated portion and a wedge-shaped portion.

19. The stator of claim 18, wherein the T-shaped elongated portion comprises a tapered segment.

20. The stator of claim 17, further comprising a mechanism that locks the at least one insert and the another insert together at the mid-point to inhibit movement between individual wires of the plurality of wires.
